(19) United States
(12) Patent Application Publication
(10) Pub. No.: US 2011/0182443 A1
(43) Pub. Date: Jul. 28, 2011

(54) ELECTRONIC DEVICE HAVING A CONTACT MICROPHONE

(76) Inventor: Anthony W. Gant, Spring, TX (US)

(21) Appl. No.: 12/694,009

(22) Filed: Jan. 26, 2010

(51) Int. Cl. H04R 3/00; G06F 3/041

(52) U.S. Cl. 381/114; 345/173; 381/122

(57) ABSTRACT

Embodiments of the present invention disclose a contact microphone for an electronic device. According to one embodiment, the electronic device includes a display lens having a front side and a backside opposite the front side, with the display lens being formed around the perimeter of a display unit. Furthermore, a contact microphone is coupled to a backside of the display lens and configured to convert acoustic signals received on the front side of the display lens.

### BACKGROUND

The popularity of consumer electronic devices has grown substantially in the last decade. Laptop computers, handhelds, and portable music players are in high demand in today's society in which a premium is placed on efficiency and mobility. These devices generally include a display enclosure and other components and sensors for facilitating communication between a user and the computer. For example, microphone sensors are utilized in a wide variety of electronic applications and are often provided within the display enclosure of an electronic device. However, as computing components continue to decrease in size, the demand for micro-machined microphones has increased. Conventional microphones require an access hole around the display enclosure in order to receive external sound waves. Furthermore, newer consumer electronic devices are moving from a traditional display enclosure to a glass, bezel-less display enclosure. Because of the difficulty in drilling holes in such glass enclosures, placement of a small microphone within this configuration becomes equally problematic.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1A is a three-dimensional perspective view of a notebook computer having a contact microphone according to an embodiment of the present invention, while FIG. 1B is a three-dimensional perspective view of an all-in-one desktop computer having a contact microphone according to an embodiment of the present invention.

FIGS. 2A-2D are exploded views of the assembly process for the display enclosure according to an embodiment of the present invention.

FIG. 3A is a top view of a display enclosure having contact microphone according to an embodiment of the present invention, and FIG. 3B is an enlarged view of the display lens and contact microphone according to an embodiment of the present invention.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As more and more consumer electronic devices move from a traditional framed bezel display enclosure to a bezel-less glass display enclosure, strategic placement of microphone sensors becomes increasingly difficult. Touchscreen technology is one example of bezel-less flush glass display enclosure. Generally, touchscreen displays or surfaces include a touch sensor having one or more layers of transparent conductive material patterned on a rigid substrate, in addition to a number of connecting traces formed along two or more sides of an inactive border area. In most bezel-less touchscreen designs, a glass lens covers the entire front surface of the display enclosure and typically cannot be cut or drilled without risking yield, assembly damage, and or raising unit cost.

Embodiments of the present invention provide a contact microphone such as a piezoelectric transducer formed in a display enclosure of an electronic device. Such a configuration serves to eliminate the need for a machined aperture in the display enclosure that enables sound to reach the microphone. That is, embodiments of the present invention provide a sealed display enclosure without a microphone access hole. Furthermore, such a configuration would allow the microphone to be placed behind the display lens and still achieve a bezel-less “flush-glass” display enclosure, particularly when the display lens itself is a touch sensor consisting of a transparent conductive array.

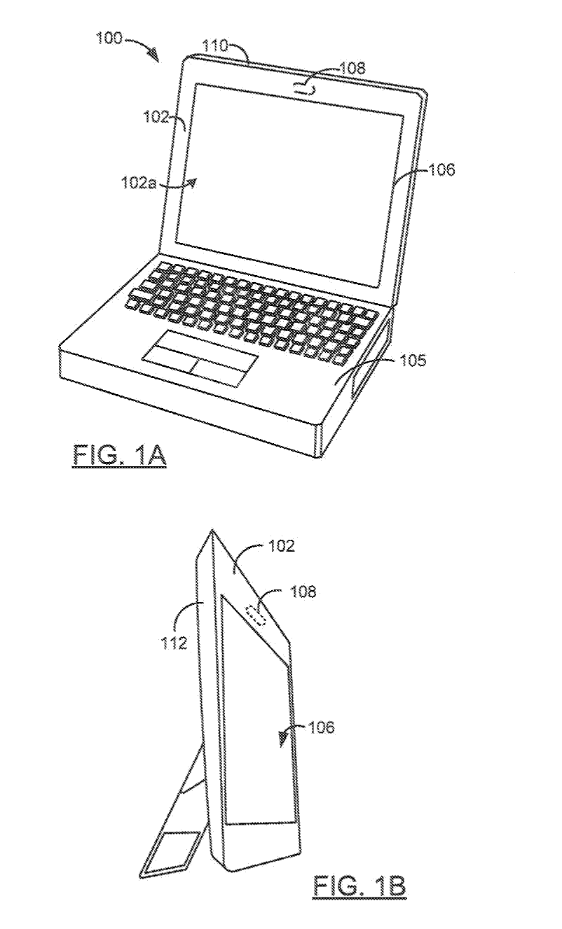

Referring now in more detail to the drawings in which like numerals identify corresponding parts throughout the views, FIG. 1A is a three-dimensional perspective view of a notebook computer having a contact microphone, while FIG. 1B is a three-dimensional perspective view of an all-in-one desktop computer having a contact microphone according to an embodiment of the present invention. As shown in these exemplary embodiments, electronic device 100 is a notebook computer (FIG. 1A) or desktop computer (FIG. 1B) comprising of an interior display unit 106, a lower housing 105, a display lens 102, an upper display housing 102, and an attached microphone 108. The interior display unit 106 is a video display device including circuitry for displaying images to a user such as a liquid crystal display (LCD), cathode ray tube (CRT) display, or similar display device.

The display lens 102 is a singular construction from glass or some other rigid material. In one embodiment, the display lens 102 is formed to be rectangular in shape with its four sides formed along the outer perimeter of the interior display 106. Furthermore, display lens 102 includes a central opening 102a so as to allow the user to view the interior display 106.

Furthermore, the microphone 108 according to one embodiment of the present invention is a contact microphone configured to receive audio vibrations through solid objects. In one embodiment, the microphone 108 is a piezoelectric transducer that picks up vibrations and converts them into corresponding electrical signals which can then be made audible. Specifically, the contact microphone 108 may include a layer of piezoelectric material positioned between two pieces of conductive material. The presence of a sound, or acoustic, wave results in induced stresses in the piezoelectric material, thereby creating a time-varying voltage signal across the material. This signal may be measured by circuits of a computer processor to determine the characteristics of the acoustic wave.

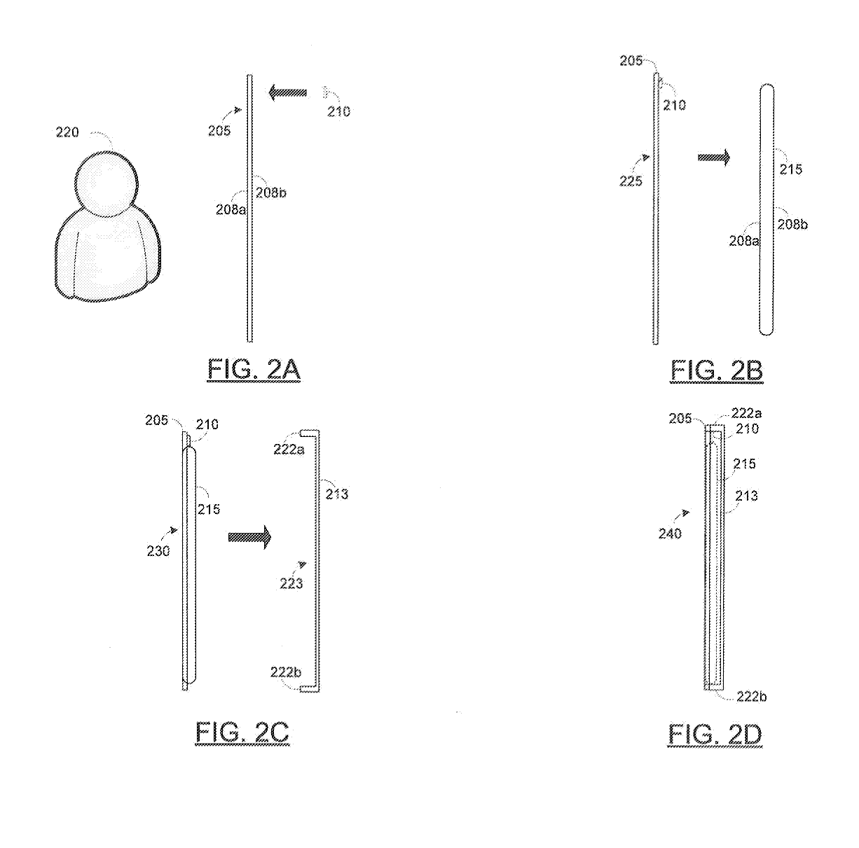

FIGS. 2A-2D are exploded views of the assembly process for the display enclosure according to an embodiment of the present invention. As shown in FIG. 2A, the display lens 205 includes a front side 208a that faces a user 220, and a backside 208b that is opposite the front side 208a. In the present embodiment, the contact microphone 210 is first coupled on the backside 208b of the display lens 205. Next, in FIG. 2B, the first assembled portion 225 including the contact microphone 210 and the display lens 205, is coupled with the display unit 215. Like the display lens 205, the display unit includes a front side 218a that faces user 220, and a backside 218b opposite the front side 218a.

As shown in the second assembled portion 230 of FIG. 2C, the contact microphone 210 is positioned just above the uppermost portion of the display unit 215. Moreover, the display lens 205 is positioned around the outer perimeter of the display unit 215 so that the front side 208a lies flush with the front side 218a of the display unit 215. The display housing 213 includes a concave opening 223 for receiving the second assembled portion 230, along with an upper flange portion 222a and bottom flange portion 222b for enclosing the display unit 215 and the display lens 205. FIG. 2D depicts the completely assembled display enclosure 240. As shown here, the upper flange portion 222a of the display housing 213 is coupled to the backside 208b of the display lens just above the contact microphone 210, while the lower flange portion 222b is positioned just below the display unit 215. However, the upper flange 222a and the lower flange 222b of the display housing 213 may be coupled at the uppermost and lowermost regions respectively of the display lens 205, rather than the backside 208b of the display lens 205.

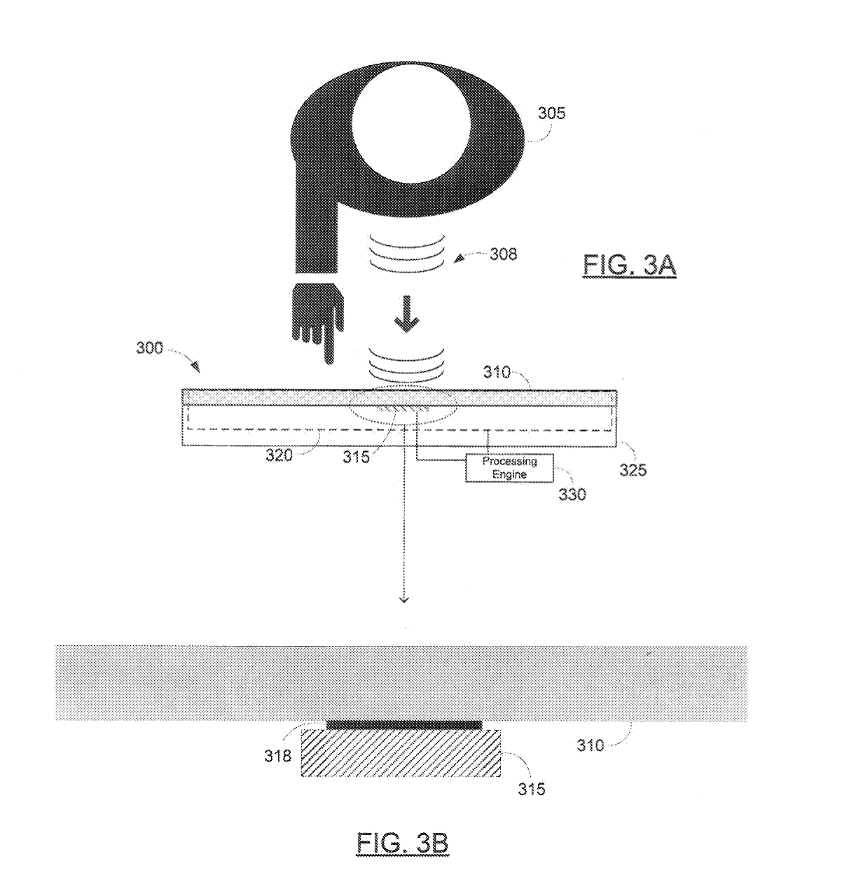

FIG. 3A is a top view of a display enclosure having a contact microphone according to an embodiment of the present invention, and FIG. 3B is an enlarged view of the display lens and contact microphone according to an embodiment of the present invention. As in the previous embodiments, the sealed display enclosure 300 shown in FIG. 3A includes a display unit 320, a display lens 310, a display housing 325, and a contact microphone 315 formed between the display unit 320 and the display lens 310. According to one embodiment, the front side of display lens 310 is formed to be in vertical alignment, or flush, with the front side of display unit 320. Furthermore, both display unit 320 and contact microphone 315 are coupled to a processing engine 330 for data output (e.g. video) to the display unit and signal conversion (e.g. sound waves) of sound waves received at the contact microphone 315.

As shown in the enlarged view of FIG. 3B, the contact microphone 315, representing a piezoelectric or similar transducer, is mechanically coupled directly to the backside of the display lens 310 via an adhesive 318. The adhesive 318 may be a drying adhesive such as glue or synthetic adhesive such as an elastic polymer. The adhesive should be sufficiently thin so as to allow the contact microphone 315 to lie substantially adjacent to the display lens 310.

As shown in FIG. 3A, acoustic signals or sound waves 308 transmitted from a user 305 (i.e. voice) or other source (e.g. music player), are first received by the display lens 310. Since the contact microphone 315 is directly connected on the backside of the front display lens 310, vibrations received on the front side of the display lens 310 are immediately felt by the contact microphone 315 on the backside thereof, thereby enabling the received sound waves to be converted into voltage for audible translation by processing engine 330. Therefore, the contact microphone of the present embodiment is acoustically coupled to the display lens 310 and capable of measuring and converting sound waves without directly receiving the acoustic signal via an opening for example.

Several advantages are afforded by the configuration of embodiments of the present invention. For example, it becomes possible to place a microphone in a glass display enclosure without the need for sound access holes. Since the contact microphone is directly coupled to the display lens of the display enclosure, such a configuration can effectively make an entire glass surface function as a part of the microphone. Accordingly, embodiments of the present invention allows for a compelling and inexpensive industrial design not possible with electronic devices utilizing conventional condenser or dynamic microphone designs.

Furthermore, while the invention has been described with respect to exemplary embodiments, one skilled in the art will recognize that numerous modifications are possible. For example, although exemplary embodiments depict a notebook computer or desktop computer as the electronic device, the invention is not limited thereto. For example, the electronic device may be a netbook, a tablet personal computer, a smart phone, or any other electronic device having a microphone and display enclosure.

Moreover, embodiments of the present invention depict a single contact microphone in a centered position on one side of the display lens. However, multiple contact microphones may be utilized and positioned at any position or side on the backside of the display lens. Thus, although the invention has been described with respect to exemplary embodiments, it will be appreciated that the invention is intended to cover all modifications and equivalents within the scope of the following claims.

What is claimed is:

1. An electronic device comprising:
a display unit;
a display lens having a front side and a backside opposite the front side, wherein the display lens is formed around the perimeter the display unit; and
a contact microphone coupled to a backside of the display lens and configured to convert acoustic signals received on the front side of the display lens.

2. The electronic device of claim 1, wherein the contact microphone is a piezoelectric transducer.

3. The electronic device of claim 1, wherein the display lens is a glass touch sensor for facilitating touch interaction with a user.

4. The electronic device of claim 1, wherein the display lens does not include an aperture for allowing sound to reach the contact microphone.

5. The electronic device of claim 1, wherein a front surface of the display lens is vertically-aligned with a front surface of the display unit.

6. The electronic device of claim 1, wherein the display unit does not include a bezel.

7. The electronic device of claim 2, wherein the contact microphone is coupled to a processing engine, and
wherein the contact microphone is configured to receive audio vibrations from the front side of the display lens and convert the audio vibrations to corresponding electrical signals capable of audible translation by the processing engine.

8. The electronic device of claim 3, wherein the touch sensor comprises of one or more layers of transparent conductive material patterned on a substrate.

9. The electronic device of claim 1, wherein the electronic device is a desktop computer, a laptop computer, a netbook, a handheld computer, or a tablet personal computer.

10. A method for integrating a microphone in an electronic device having bezel-less display enclosure;
forming a display lens around the perimeter of a video display unit; and
attaching a contract microphone to a backside of the display lens, wherein the contact microphone is configured to convert acoustic signals received on the front side of the display lens.

11. The method of claim 10, wherein the contact microphone is a piezoelectric transducer.

12. The method of claim 10, wherein the display lens is a glass touch sensor for facilitating touch interaction with a user.

13. The method of claim 10, wherein the display lens does not include an aperture for allowing sound to reach the contact microphone.

14. The method of claim 10, wherein a front surface of the display lens is vertically-aligned with a front surface of the video display unit.

15. The method of claim 11, wherein the contact microphone is coupled to a processing engine, and
wherein the contact microphone is configured to receive audio vibrations from the front side of the display lens and convert the audio vibrations to corresponding electrical signals capable of audible translation by the processing engine.

16. The method of claim 12, wherein the touch sensor comprises of one or more layers of transparent conductive material patterned on a substrate.

17. A display enclosure for an electronic device having a display unit, the display enclosure comprising:
a display lens formed around the perimeter of the display unit; and
a piezoelectric transducer coupled to a backside of the display lens and configured to convert acoustic signals received on the front side of the display lens,
wherein the display lens does not include an aperture for allowing sound to reach the piezoelectric transducer.

18. The display enclosure of claim 17, wherein the display lens is a glass touch sensor for facilitating touch interaction with a user.

19. The display enclosure of claim 17, wherein a front surface of the display lens is vertically-aligned with a front surface of the display unit.

20. The display enclosure of claim 17, wherein the contact microphone is coupled to a processing engine, and
wherein the contact microphone is configured to receive audio vibrations from the front side of the display lens and convert the audio vibrations to corresponding electrical signals capable of audible translation by the processing engine.
